(19) United States
(12) Patent Application Publication
(10) Pub. No.: US 2004/0065018 A1
(43) Pub. Date: Apr. 8, 2004

(54) Conduitless window regulator

(76) Inventors: Luc R. Regnier, Toronto (CA); Denis R. Cloutier, Newmarket (CA)

Correspondence Address: Robin W Asher, Clark Hill, Suite 3500, 500 Woodward Avenue, Detroit, MI, 48226-3435, US

(21) Appl. No.: 10/466,380

(22) PCT Filed: Jan. 21, 2002
(86) PCT No.: PCT/CA02/00081

(51) Int. Cl. E05F 15/16

(52) U.S. Cl. 49/352; 49/349; 49/348; 49/374

(57) ABSTRACT

A window regulatoR (10) for operating a window pane of vehicle comprises a base plate (12) having a guide rail (20). A lifter plate (26) is slidably coupled to the guide rail (20) and adapted for supporting the window pane. A motor assembly (32) is secured to the base plate (12) and includes a drive housing and a power motor. A drive shaft, rotatably journaled to the drive housing, has a disc flange supporting a cylindrical shaft and a key shaft spaced from and parallel to the cylindrical shaft. A top and bottom cable (34, 36) drum are supported on the drive shaft, each of the cable drums including a key slot for aligning with and receiving the key shaft therethrough. The lifter plate is secured to the cable (38) between first and second pulleys (22, 24). A pair of compression springs (64) are coupled to the respective cable drums in opposite directions and maintaining tension on the cable.

### FIELD OF THE INVENTION

This invention relates to a conduitless window regulator for a cable driven window lifter in an automotive vehicle which maintains tension in the cable during operation of the window regulator.

### BACKGROUND OF THE INVENTION

Window regulators for a cable driven window lifter in an automotive vehicle commonly include a closed loop cable for transferring a force supplied by a motor to lift or lower a window pane. Opposing ends of the cable are secured to a cable drum and the cable is typically wound around the cable drum which is rotationally driven by the motor. The cable is also guided around upper and lower cable pulleys supported by opposing ends of a guide rail. A lifter is slidably coupled to the guide rail and attached to the cable between the upper and lower pulleys. The window pane is secured to the lifter such that the window pane is lifted or lowered by movement of the lifter along the guide rail between the upper and lower pulleys. This type of window regulator is disclosed in U.S. Pat. No. 5,047,077.

Window regulators also often incorporate means for compensating for cable slackness when the lifter is in a relaxed state; that is, not lifting or lowering the window pane. The U.S. Pat. No. 5,857,635 discloses a window regulator wherein one end of the cable is attached to a cable drum and the opposite end of the cable is attached to a conduit-like slide disposed inside the cable drum. When the cable is unloaded, a spring urges the slide rotationally about the cable drum to take up cable slackness. However, the slide does not maintain tension in the cable when the window pane is lifted or lowered by rotation of the cable drum.

### SUMMARY OF THE INVENTION

According to one aspect of the invention, there is provided a window regulator for operating a window pane of an automotive vehicle comprising a base plate having a guide rail extending between opposite upper and lower ends. A lifter plate is slidably coupled to the guide rail and adapted for supporting the window pane. A motor assembly is secured to the base plate and includes a drive housing and a power motor. A drive shaft is rotatably journaled to the drive housing. The drive shaft has a support flange supporting a center shaft and a key shaft spaced from and parallel to the center shaft. A pair of cable drums are supported on the drive shaft, each of the cable drums including a key slot for aligning with and receiving the key shaft therethrough. A cable having a first end connected to one of the cable drums is at least partially wound around the drum in a first direction while a second end is connected to the other of the cable drums and at least partially wound around the other drum in a second direction opposite the first direction. The lifter plate is secured to the cable between the first and second ends. A compression spring is operatively engaged with each of the respective cable drums for engagement between the key shaft and the drums for biasing the drums in opposite directions and maintaining tension on the cable between the first and second ends.

### BRIEF DESCRIPTION OF THE DRAWINGS

In drawings which illustrate embodiments of the present invention,

FIG. 1 is perspective view of the window regulator according to the subject invention;

FIG. 2 is an exploded perspective view of FIG. 1;

FIG. 3 is an exploded perspective view of the motor assembly and cable drums;

FIG. 4 is an assembled perspective view of FIG. 3;

FIG. 5 is an exploded perspective view of an alternative embodiment of the window regulator;

FIG. 6 is a top view of a partially assembled window regulator according to the alternative embodiment of the invention;

FIG. 7 is a perspective view of an alternative cable drum for use with the alternative embodiment of the invention;

FIG. 8 is a perspective view of an alternative compression spring;

FIG. 9 is a perspective view of yet another alternative compression spring; and

FIG. 10 is a perspective view of still another alternative compression spring.

### DETAILED DESCRIPTION OF THE INVENTION

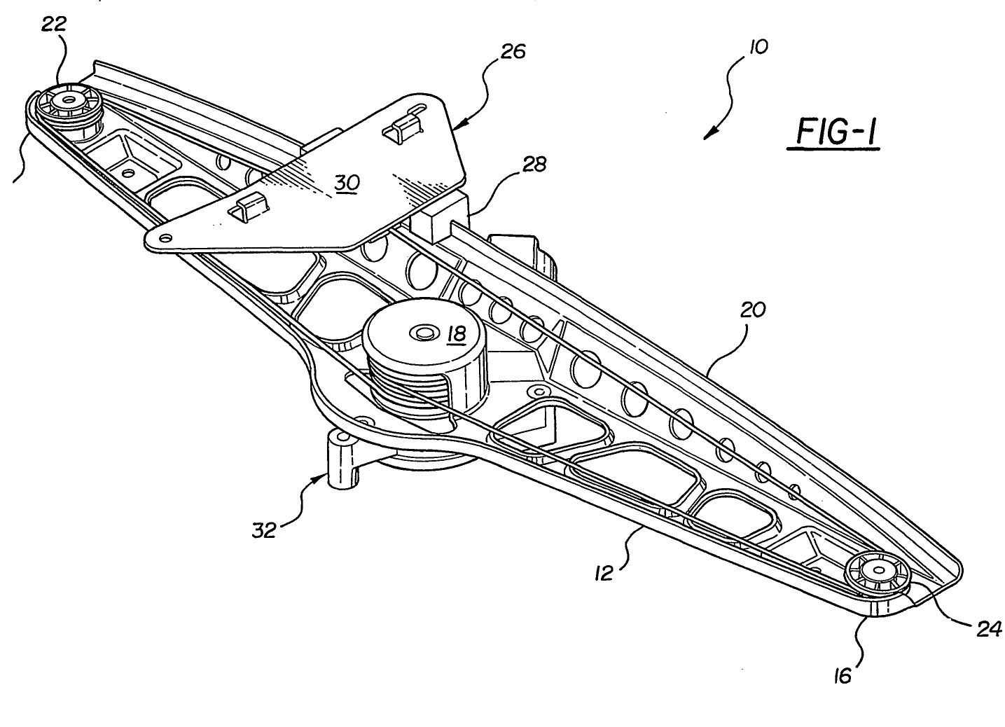

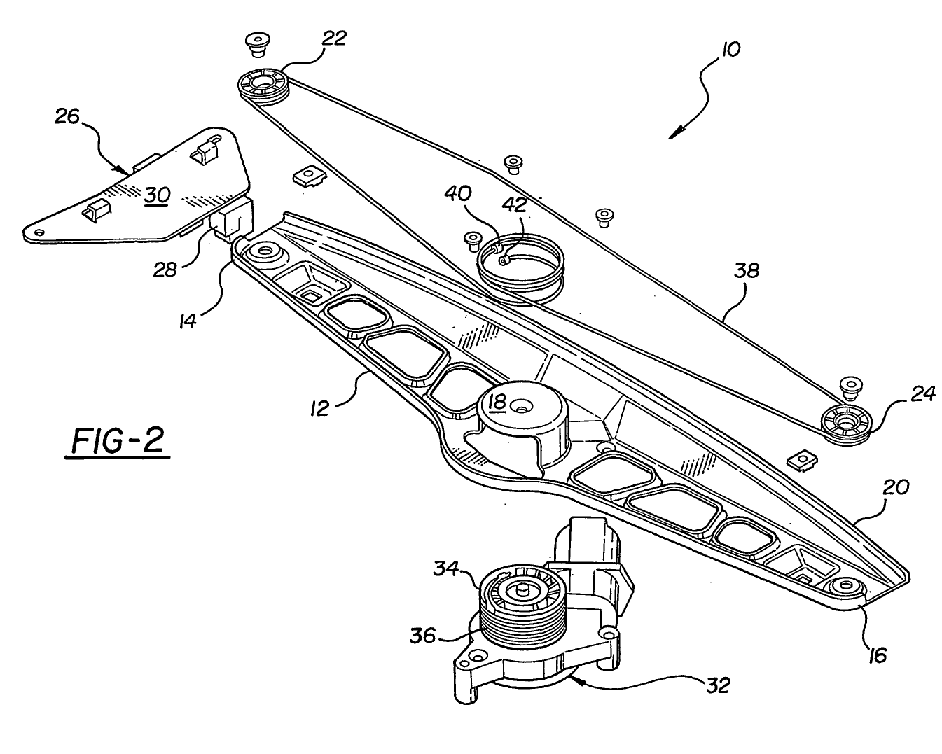

Referring to FIGS. 1 and 2, the conduitless window regulator is generally illustrated at 10. The window regulator 10 includes an elongated base plate 12 extending between an upper end 14 and a lower end 16. A raised cylindrical housing 18 is centered between the upper and lower end 14, 16. The base plate 12 further includes a guide rail 20 extending between the upper and lower end 14, 16 adjacent the housing 18. An upper pulley 22 is rotatably secured to the upper end 14 and a lower pulley 24 is rotatably secured to the lower end 16 of the base plate 12.

The window regulator 10 further includes a lifter plate 26 having a slide block 28 slidably coupled to the guide rail 20 on the base plate 12 for movement therealong between the upper and lower ends 14, 16. A window support plate 30 is secured to the slide block 28 for securing and supporting a lower portion of a window pane of an automotive vehicle as is commonly known in the art.

The window regulator 10 also includes a motor assembly 32 secured to the base plate 12 in opposite facing relationship to the raised cylindrical housing 18. A pair of disc-like cable drums 34, 36 are seated within the housing 18 and in operative engagement with the motor 32 as will be further described hereinbelow. A cable 38 is provided having opposite first and second ends 40, 42 secured to the respective cable drums 34, 36. The cable 38 is wound around each of the upper and lower pulleys 22, 24 and the lifter plate 26 is fixedly secured to the cable 38 between the upper and lower pulleys 22, 24. Alternatively, the window regulator 10 may include a pair of cables, one of which is connected between the upper pulley 22 and the top of the lifter plate 26 and the other of which is connected between the lower pulley 24 and the bottom of the lifter plate 26. Each of the cables may be at least partially wound around the respective cable drums 34, 36 and function similar to that of the single cable 38.

The motor assembly 32 rotates the cable drums 34, 36 is either the clockwise or counterclockwise direction to pull on the cable 38 and move the lifter plate 26 between the upper and lower pulleys 22, 24 to lift or lower the window pane. The subject invention relates to the cable drums 34, 36 providing constant tension on the cable 38 during the lifting or lowering of the window pane and in a relaxed position, or pre-loaded state.

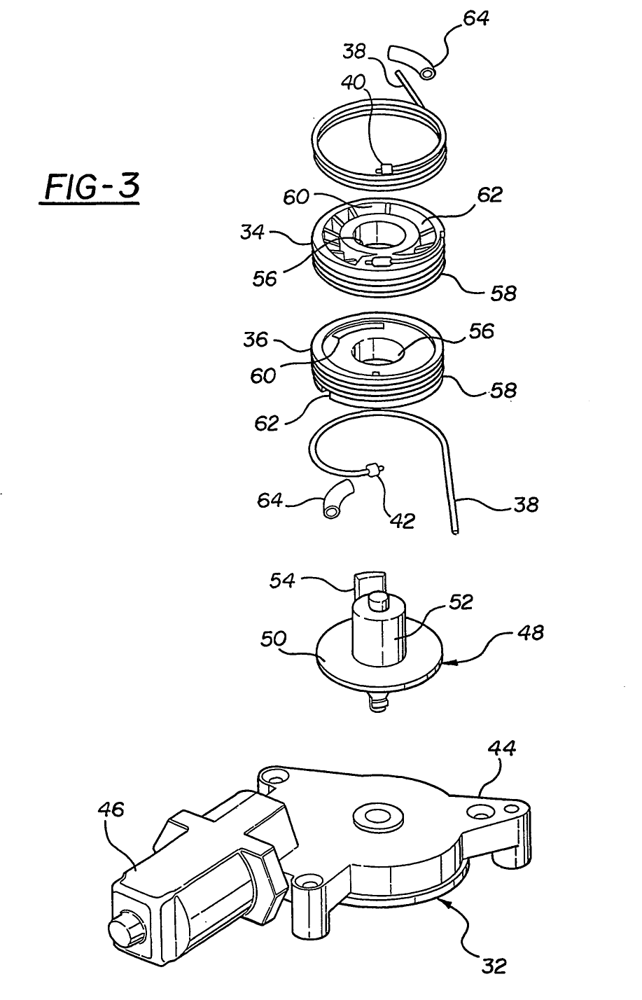

Specifically, referring to FIG. 3, the motor assembly 32 includes a drive housing 44 supporting a power motor 46. A drive shaft 48 is coupled to the drive housing 44 for rotation in both a clockwise and counterclockwise direction. The drive shaft 48 includes a disc-like support flange 50 for supporting the cable drums 34, 36, a cylindrical center shaft 52 projecting from the flange 50 and extending through the center of each of the cable drums 34, 36, and a key shaft 54 projecting from the perimeter of the flange 50 adjacent to and spaced from the shaft 52.

Each of the cable drums 34, 36 include a center bore 56 for receiving the shaft 52 and a series of helical outer perimeter grooves 58 for receiving and winding the cable 38 therearound. The cable drums 34, 36 are symmetrical, and therefore, further details of the top cable drum 34 will be described. The drum 34 includes a key slot 60 for receiving the key shaft 54 therethrough and a recessed spring pocket 62 for receiving and supporting a spring 64 compressed by the key shaft 54. The spring 64 in the embodiment of FIGS. 1-4 is a coil-type compression spring for placement within the spring pocket 62 of each of the top and bottom drums 34, 36. It should be appreciated, however, that other types of springs may be utilized. For example, a coiled leaf-type spring may be used which is seated about the shaft 52 and key 54 having free ends for engagement between the key and the end of the slot 60 to compress the spring and tension the cable 38.

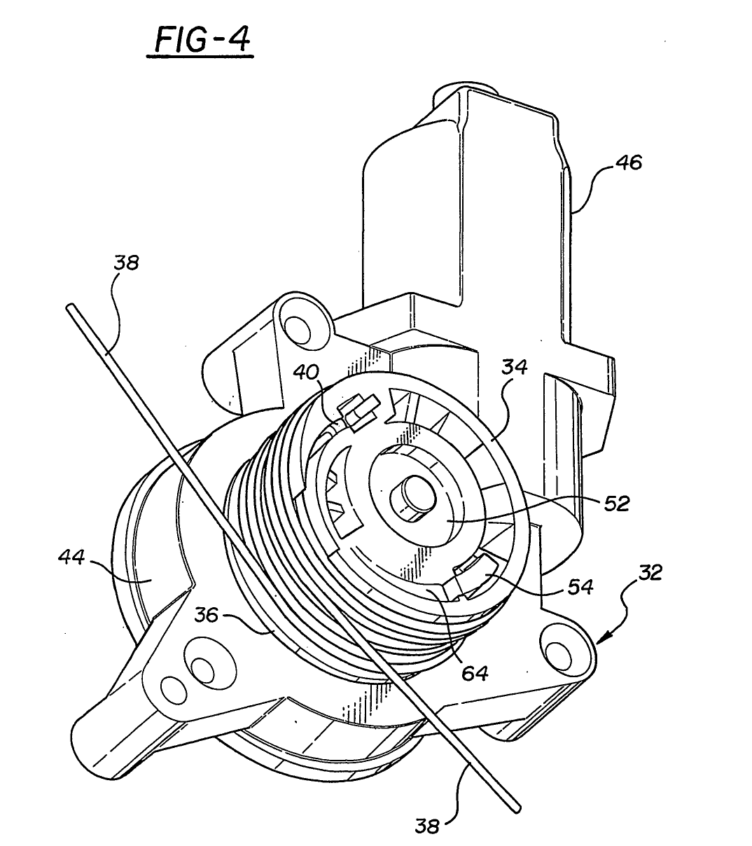

The first end 40 of the cable 38 is fixedly secured to the top cable drum 34 and the cable 38 is partially wound around the drum 34 in a counterclockwise direction resting within the helical grooves 58. Similarly, the second end 42 of the cable 38 is fixedly secured to the bottom drum 36 and the cable 38 is partially wound around the drum 36 in a clockwise direction resting within the helical grooves 58. FIG. 4 discloses the cable drums 34, 36 and cable 38 assembled to the motor assembly 32.

In operation, during assembly, the compression springs 64 are placed into the spring pockets 62 of the respective top and bottom cable drums 34, 36. The bottom drum 36, with the cable 38 attached thereto, is placed on the shaft 52 with the spring 64 facing the shaft flange 50 and the key slot 60 aligned with the key shaft 54. The top drum 34, also with the cable 38 attached thereto, is then place on the shaft 52 with the spring 64 facing away from the flange 50 and the key slot 60 aligned with the key shaft 54. The drums 34, 36 are free to partially rotate on the shaft 52 approximately 2 mm due to a spaced created between the opposing sides of the key 54 and the springs 64. That is, the spring 64 of the bottom drum 36 is positioned slightly spaced from one side of the key 54 and the spring 64 of the top drum is positioned slightly spaced from the opposite side of the key 54.

In a pre-loaded state, with the window regulator 10 fully assembly as shown in FIG. 1, the lifter plate 26 is positioned midway along the guide rail 20 between the upper and lower pulleys 22, 24. The predetermined length of the cable 38 will cause the top and bottom drums 34, 36 to be positioned on the shaft 52 in such a way that the key shaft 54 is forced approximately 1-2mm from the end of the slot 60 in the lower drum 36 and the spring 64 is fully compressed in the spring pocket 62. When the motor 46 is powered to rotate the drive shaft 48 in a clockwise direction, the key shaft 54 will engage and compress the spring 64 in the upper drum 34 until the key 54 contacts the end of the slot 60. The cable 38 winds around the drum 34 as it rotates and thus pulls the lifter plate 26 downwardly to lower the window pane. The bottom drum 36 maintains its pre-loaded state as it simultaneously rotates to maintain tension on the cable 38 while it unwinds from the bottom drum 36.

After the lifter plate 26 reaches the bottom of the rail 20, the motor 46 stops powering the drive shaft 48 and the drums 34,36 are maintained in the current operating state. When the motor 46 is reversed to turn the drive shaft 48 and drums 34, 36 in the counterclockwise direction, the opposite movement of the key 54 with the drums 34, 36 occurs.

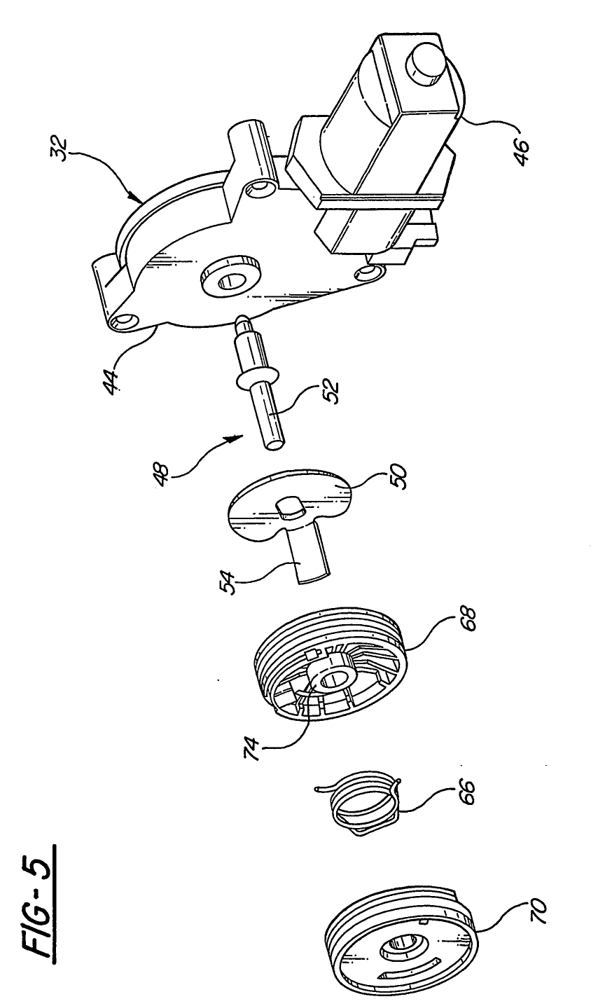

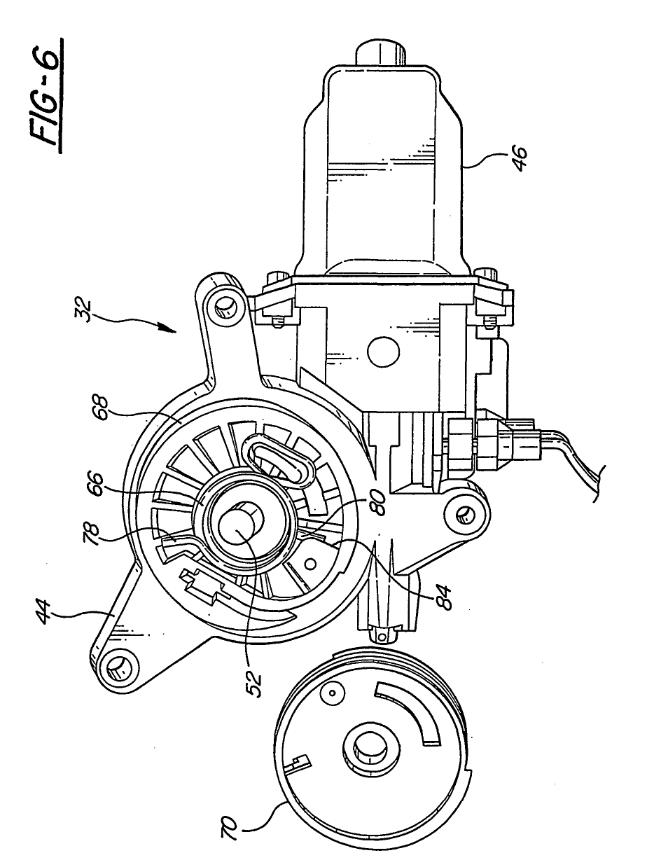

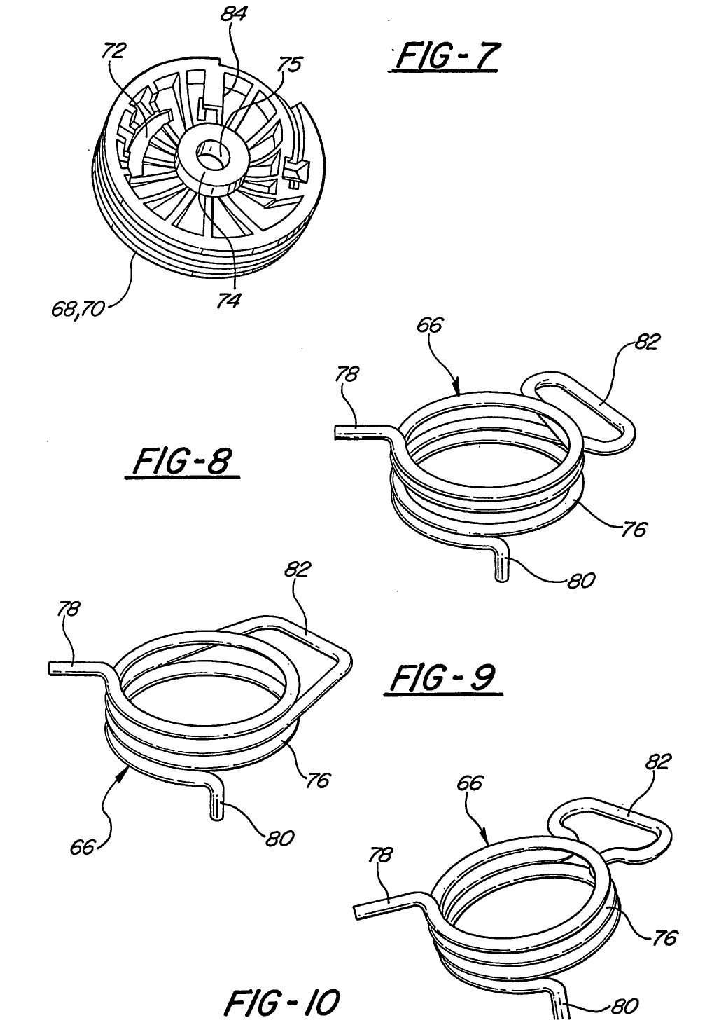

Referring to FIGS. 5-10, an alternative embodiment of the cable drums and compression spring is shown. The alternative embodiment includes a single compression spring 66 positioned between and operatively engaged with each of the cable drums 68, 70. Specifically, the first cable drum 68 is centered on the center drive shaft 52 and supported by the flange 50. The key shaft 54 is similarly received through a key slot 72 of the drum 68. The drum 68 includes a raised hub 74 surrounding its center bore 75 for receiving and supporting the compression spring 66. The second cable drum 70 is then centered on the center drive shaft 52 and supported by the first drum 68. The key shaft 54 is received through the key slot 72 of the second drum 70 and the spring 66 is seated on the raised hub 74 thereof such that the compression spring 66 is positioned between the drums 68, 70.

Referring specifically to FIGS. 8-10, the compression spring 66 includes a cylindrical coil 76 terminating at upper and lower outwardly projection spring tabs 78, 80. A portion of the coil 76 forms a projecting loop 82 for receiving the key shaft 54 therethrough to prevent rotation of the spring 66 relative to the drums 68, 70. The loop 82 may be formed in varying configurations as desired and as shown in FIGS. 8-10.

Each of the drums 68, 70 further include a vertical blocking wall 84 for abutting with the respective upper and lower spring tabs 78, 80 and for biasing the drums 68, 70 in the respective clockwise and counterclockwise directions similar to the first embodiment to take up slack in the cable 38 wound around the drums 68, 70. The operation of the alternative embodiment is the same as the first embodiment, except a single coiled compression spring 66 is utilized between the first and second drums 68, 70 and keyed to the key shaft 54.

The above-described embodiment of the invention is intended to be an example of the present invention and alterations and modifications may be effected thereto, by those of skill in the art, without departing from the scope of the invention.

What is claimed is:

1. A window regulator for operating a window pane of an automotive vehicle comprising:
a base plate having a guide rail extending between opposite upper and lower ends;
a lifter plate slidably coupled to said guide rail and adapted for supporting the window pane;
a motor assembly secured to said base plate, said motor assembly including a drive housing and a power motor;
a drive shaft rotatably journaled to said drive housing for rotation by said power motor, said drive shaft having a support flange supporting a center shaft and a key shaft spaced from and parallel to said center shaft;
a pair of cable drums received on said center shaft and supported by said drive shaft, each of said cable drums including a key slot for aligning with and receiving said key shaft therethrough;
a cable having a first end connected to one of said cable drums and at least partially wound around said drum in a first direction and a second end connected to said other of said cable drums and at least partially wound around said other drum in a second direction opposite said first direction, said lifter plate secured to said cable between said first and second ends; and
a compression spring operatively engaged with each of said respective cable drums for engagement between said key shaft and said drums for biasing said drums in opposite directions and maintaining tension on said cable between said first and second ends.

2. A window regulator as set forth in claim 1 wherein each of said drums includes a spring pocket for engaging at least a portion of said compression spring to compress said spring between said respective drum and said key shaft.

3. A window regulator as set forth in claim 2 wherein each of said drums includes a center bore for receiving said center shaft therethrough to mount said drums on said drive shaft.

4. A window regulator as set forth in claim 3 wherein each of said drums include a series of helical outer perimeter grooves for receiving and winding said cable around each of said respective drums in said opposite first and second directions.

5. A window regulator as set forth in claim 4 wherein each of said drums include a raised hub surrounding said center bore.

6. A window regulator as set forth in claim 5 wherein said compression spring includes a coil seated around each of said raised hubs between said first and second drums.

7. A window regulator as set forth in claim 6 wherein said coil terminates at radially spaced apart upper and lower outwardly projection spring tabs 78, 80.

8. A window regulator as set forth in claim 7 wherein said spring pocket forms a vertical wall in each of said first and second drums for engaging said respective upper and lower spring tabs.

9. A window regulator as set forth in claim 8 wherein said coil forms a projecting loop for receiving said key shaft therethrough to prevent rotation of said compression spring relative to said drums.

10. A window regulator as set forth in claim 4 further including a first compression spring seated in said spring pocket of said first cable drum and compressed between said drum and said key shaft and a second compression spring seating in said spring pocket of said second cable drum and compressed between said drum and said key shaft during rotation of said cable drums in said respective first and second directions.

11. A window regulator as set forth in claim 9 wherein said base plate includes a upper pulley rotatably supported at said upper end and a lower pulley rotatably supported at said lower end, said cable wound around each of said upper and lower pulleys between said cable drums and said lifter plate.

12. A window regulator as set forth in claim 11 wherein said base plate includes a raised cylindrical housing between said upper and lower ends for receiving and supporting said cable drums on said base plate.

13. A window regulator as set forth in claim 12 wherein said lifter plate includes a slide block slidably coupled to said guide rail of said base plate and a support plate mounted to said slide block for supporting the window pane during movement between said upper and lower ends of said base plate.

14. A window regulator for operating a window pane of an automotive vehicle comprising:
a base plate having a guide rail extending between opposite upper and lower ends;
a lifter plate slidably coupled to said guide rail and adapted for supporting the window pane;
a motor assembly secured to said base plate, said motor assembly including a drive housing and a power motor;
a drive shaft rotatably journaled to said drive housing for rotation by said power motor, said drive shaft having a support flange supporting a center shaft and a key shaft spaced from and parallel to said center shaft;
a pair of cable drums received on said center shaft and supported by said drive shaft, each of said cable drums including a key slot for aligning with and receiving said key shaft therethrough;
a first cable having a first end connected to one of said cable drums and at least partially wound around said drum in a first direction and a second end connected to said lifter plate;
a second cable having a first end connected to the other of said cable drums and at least partially wound around said other drum in a second direction opposite said first direction and a second end connected to said lifter plate; and
a compression spring operatively engaged with each of said respective cable drums for engagement between said key shaft and said drums for biasing said drums in opposite directions and maintaining tension on said cable between said first and second ends.
